(19) United States
(12) Patent Application Publication
(10) Pub. No.: US 2018/0185990 A1
(43) Pub. Date: Jul. 5, 2018

(54) HOOK NOSE PLIERS SYSTEM

(71) Applicant: DAVE STULL, Nanaimo (CA)

(72) Inventor: DAVE STULL, Nanaimo (CA)

(21) Appl. No.: 15/396,377

(22) Filed: Dec. 30, 2016

(51) Int. Cl. B25B 7/02; B25B 27/14; B25G 1/10; B25G 1/12; H01R 43/26

(52) U.S. Cl. CPC B25B 7/02; B25B 27/14; H01R 2201/26; B25G 1/12; H01R 43/26; B25G 1/102

(57) ABSTRACT

A set of pliers having a linear crab claw configuration at its distal end, a front section, an upper work member, a lower work member, an axle, a pair of elongated handles and a pair of ergonomic grips. The set of pliers is configured with the front section to extend forward from a pivot point, wherein the pivot point is rotatable on the axle and the upper work members and the lower work member include the linear crab claw configuration, and the linear crab claw configuration comprises a linear arcuate, convexly curved contour useful for simultaneously grasping a mechanical electrical connector and releasing the locking mechanism for removal and/or installation.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### FIELD OF THE INVENTION

The present invention relates generally to the field of hand tools and more specifically relates to pliers.

### DESCRIPTION OF RELATED ART

In the field of automotive repair, pliers are commonly used as a simple and convenient way to grasp and install or remove various components. One such component used extensively in the automotive industry is the mechanical electrical connector. These connectors are held in place by a retention locking mechanism which must be pressed and held while disconnecting the electrical connector for testing or repairs. These connectors can be very difficult to remove by hand due to location and/or the built up corrosion and debris thereby requiring the use of pliers. The pliers commonly found in the art are of a general use design and may cause damage to the connector, locking mechanism and surrounding components.

A common problem experienced by people working in the automotive trade is that they are faced with vast numbers of wire connectors, with a multitude of different designs. All connector are affected by age, dirt, damage, all causing them to be very difficult to disconnect. Many connectors are in hard-to-reach positions for finger-tightening or loosening. This is not desirable.

U.S. Pat. No. 3,895,214 to Robin L. Winter relates to a component removal tool. The described component removal tool includes an apparatus for removing solder-mounted components from substrate surfaces which comprises plier means having a pair of relatively movable arms pivotally mounted together and forming a pair of oppositely disposed gripping handles and a pair of oppositely disposed working legs. The forward and inward exposed surfaces of each of the heads are arranged in mutually converting relationship at an acute angle relative to the longitudinal axis of the leg to which it is secured to define a wedge-shaped configuration. The legs are resilient biased apart by a spring between the handles.

### BRIEF SUMMARY OF THE INVENTION

In view of the foregoing disadvantages inherent in the known pliers art, the present disclosure provides a novel hook nose pliers. The general purpose of the present disclosure, which will be described subsequently in greater detail, is to provide a hook nose pliers comprising:

The present invention comprises a set of pliers having a linear crab claw configuration at its distal end, a front section, an upper work member, a lower work member, an axle, a pair of elongated handles and a pair of ergonomic grips. The set of pliers is configured with the front section to extend forward from a pivot point,; wherein the pivot point is rotatable on the axle and the upper work members and the lower work member include the linear crab claw configuration. The linear crab claw configuration comprises a linear arcuate, convexly curved contour thereby providing increased functional and novel use for removing such fasteners in an efficient manner.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a hook nose pliers system, constructed and operative according to the teachings of the present disclosure.

FIG. 1 is a perspective view of the hook nose pliers system during an ‘in-use’ condition, according to an embodiment of the disclosure.

FIG. 2 is a perspective view of the hook nose pliers system of FIG. 1, according to an embodiment of the present disclosure.

FIG. 3 is a side view of the hook nose pliers system of FIG. 1, according to an embodiment of the present disclosure.

FIG. 4 is a perspective view of the mechanical electrical connectors of FIG. 1, according to an embodiment of the present disclosure.

FIG. 5 is a top perspective view of the hook nose pliers system of FIG. 1, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a hand tool and more particularly to a hook nose pliers as used to improve the use of pliers to simultaneously grasp a mechanical electrical connector and release the locking mechanism for removal and/or installation.

Generally speaking, the device disclosed herein is a wire disconnect tool comprising a pair of work members stretching laterally, a set of handle grips extending from the pair of work members. The set of handle grips enable a user to manipulate the pair of work members. A pivot is attached between the pair of work members and the set of handle grips, to enable the set of handle grips to move the pair of work members. The device also comprises a pair of tips attached to a distal end of the pair of work member, and a set of inward projections fastened to the pair of tips; wherein the set of inward projection engage a wire connector to permit a user to squeeze the set of handle grips thus tightening the pair of work members in order to dislodge the wire connector. The advantage of this tool over regular needle nose pliers or extracting tools is that with conventional tools the user has to put an excessive amount of pressure on the connector to obtain sufficient grasp to pull the connectors apart causing damage to the connector. The present invention solves this problem via the structural design described.

In an embodiment the hook nose pliers may be configured having an overall tool length 180 mm, handle length 120 mm, the jaw member length 60 mm, and the curved inward faced projections start 5 mm from the distal end of jaw members and the curved inward facing projections, projecting 2.5 mm. Although the main use of this tool is to grasp locking mechanism and separate wire connectors it may also provide a multi tool use for any suitable mechanical project.

Thus, using the present tool the user can apply minimal pressure on the connector to gain sufficient grasp to release the locking mechanism and to separate the connector damage free. The tool may also find daily use as a tool for grasping, holding, pulling, extracting, and supporting different projects, making it a multi use tool.

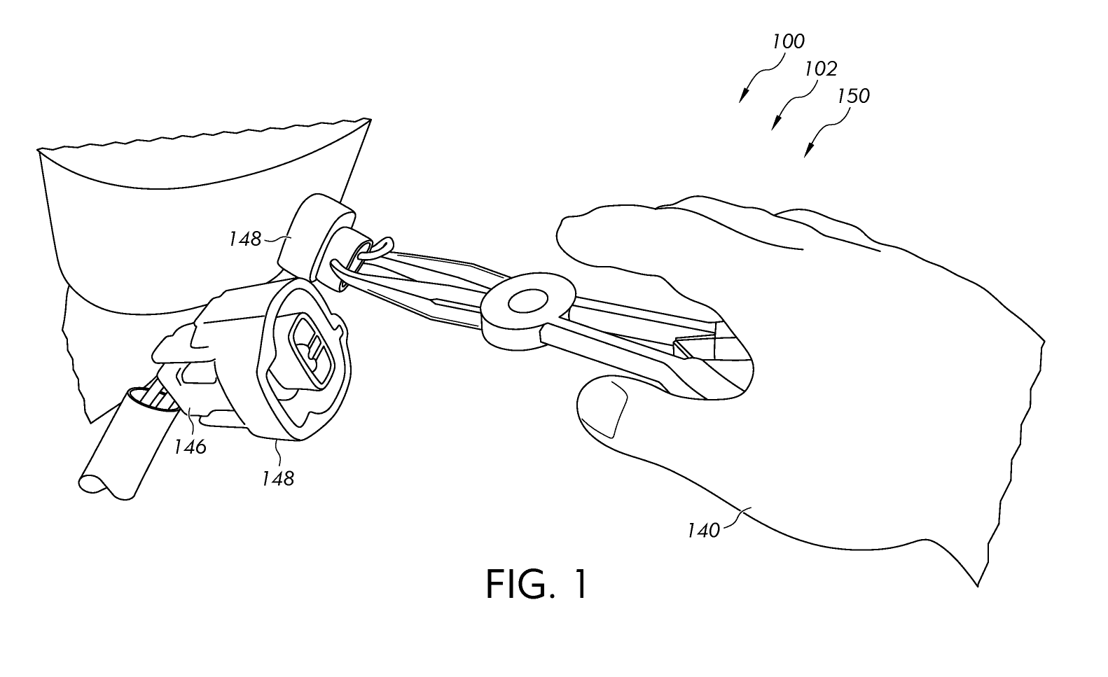

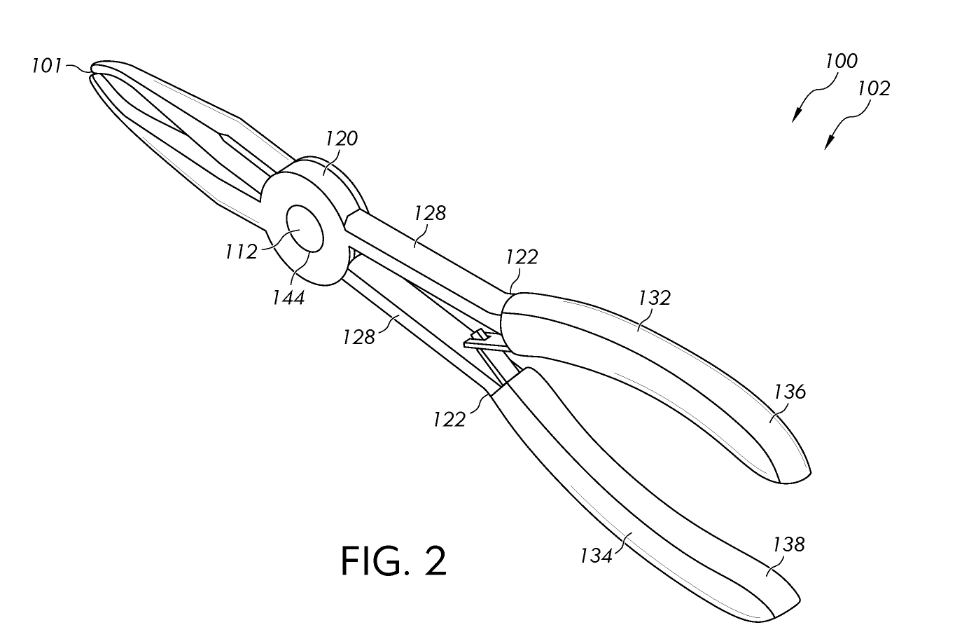

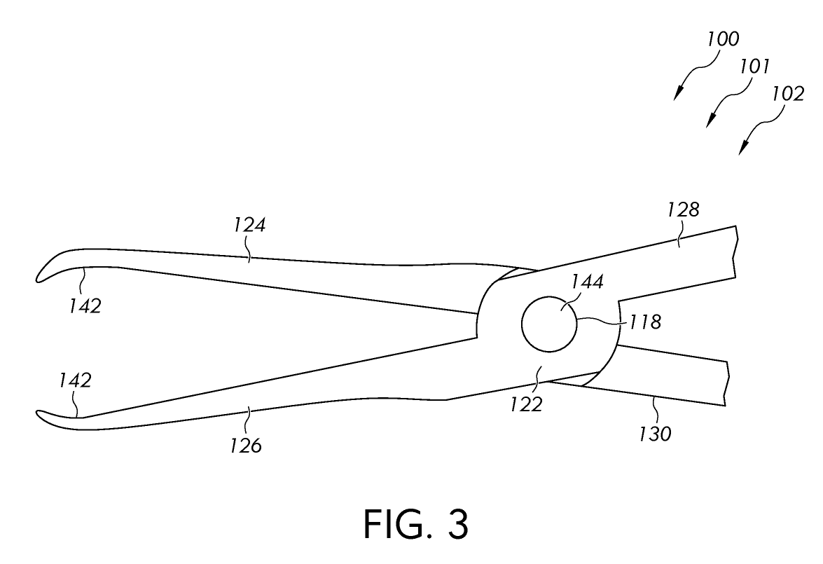

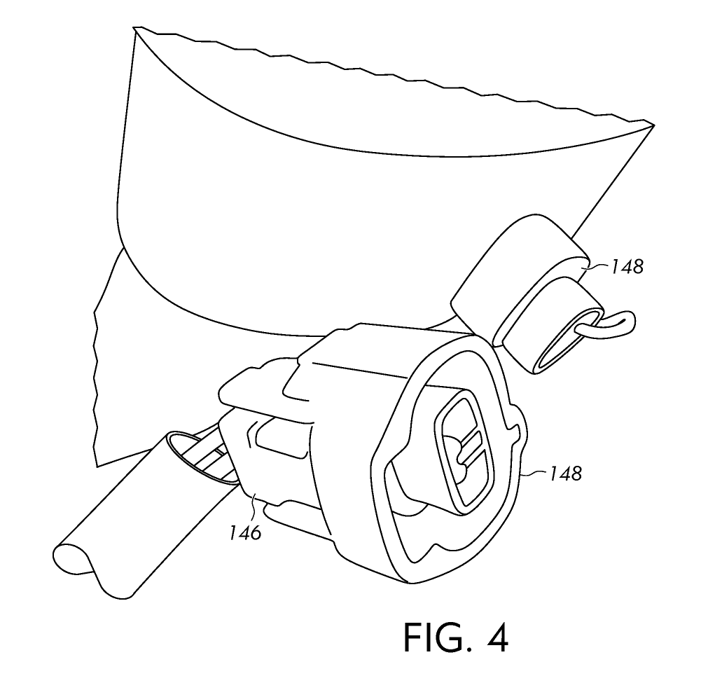

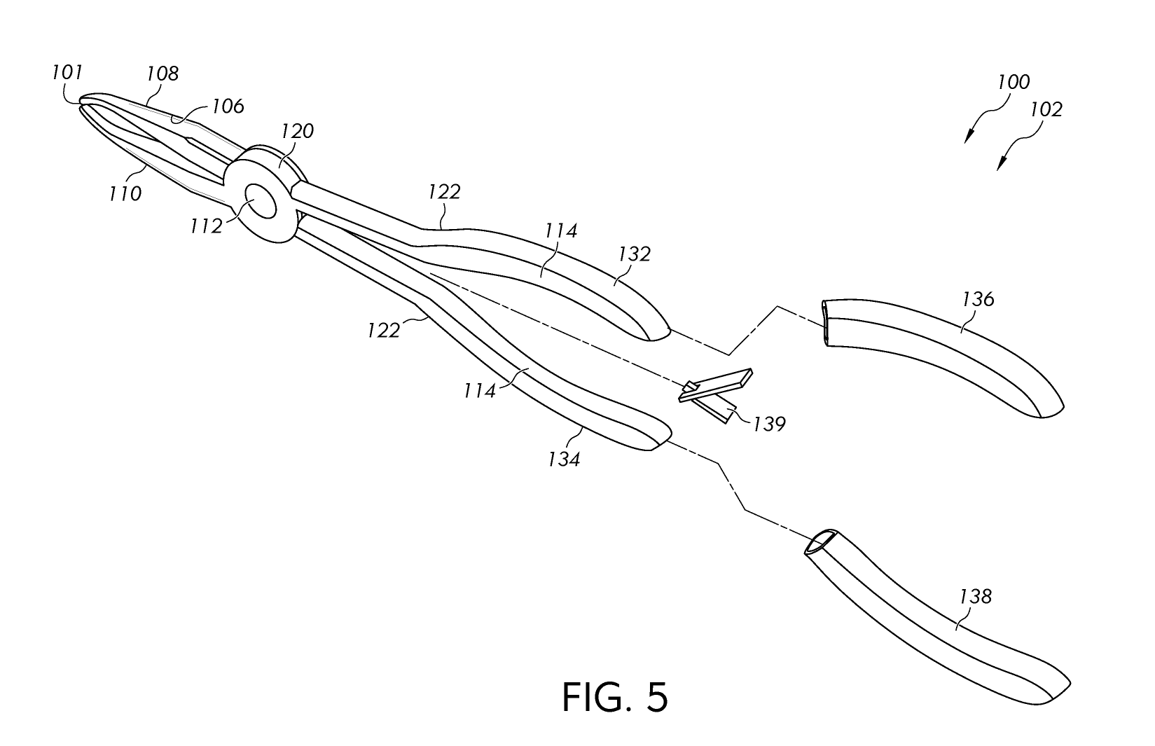

Referring now more specifically to the drawings by numerals of reference, there is shown in FIGS. 1-5, various views of a hook nose pliers system 100. FIG. 1 shows a hook nose pliers system 100 during an ‘in-use’ condition 150, according to an embodiment of the present disclosure. Here, the hook nose pliers system 100 may be beneficial for use by a user 140 to disengage a retaining lock of mechanical electrical connectors. As illustrated, the hook nose pliers system 100 may include a set of pliers having a linear crab claw configuration.

According to one embodiment, the hook nose pliers system 100 may be arranged as a kit 105. In particular, the hook nose pliers system 100 may further include a set of instructions 155. The instructions 155 may detail functional relationships in relation to the structure of the hook nose pliers system 100 (such that the hook nose pliers system 100 can be used, maintained, or the like, in a preferred manner).

The hook nose pliers system 100 comprises: a set of pliers having a linear crab claw configuration 101, at its distal end including, a front section 106, an upper work member 108, a lower work member 110, an axle 112, a pair of elongated handles 114, and a pair of ergonomic grips 116. The set of pliers is configured with a front section 106, to extend forward from a pivot point 118; the pivot point 118 is rotatable on the axle 112, and the upper work member 108, and the lower work member 110, are in a linear crab claw configuration 101. The linear crab claw configuration 101 comprises a linear arcuate, convexly curved contour 142.

The hand tool for mechanical electrical connectors 102, is configured to disengage a retaining lock 146 of mechanical electrical connectors 148. Further the hand tool for mechanical electrical connectors 102, can be made of high strength alloy including a front section 106, that is substantially triangular in shape having a small point and expanding in width rearwardly. At least a portion of the front section 106, has a linier crab claw configuration 101; wherein the front section 106, is integral with a mid section 120, that provides a journal 144, for receiving an axle 112.

Referring now to the front section 106; the front section 106 is defined by an upper work member 108, and a lower work member 110 in functional combination. The upper work member 108, and lower work member 110 are connected with and extending from the ends of each mid section 120. The mid section 120, further includes an upper leveraging arm 128, and a lower leveraging arm 130 extending rearwardly. The upper work member 108, and the lower work member 110 pivot around an axle 112, and at least, a portion of the upper leveraging arm 128, and the lower leveraging arm 130 have an arcuate, convexly curved contour 142, including a pair of ergonomic hand grips 116, having a hollow body.

The ergonomic hand grips 116 each have a hollow body which is configured to fit tightly about the outer surface of the upper leveraging arm 128 and the upper leveraging arm 128. The ergonomic hand grips 116, are made of electrical insulating material and further include at least one releasably engagable leaf spring 139, that is frictionally held in a forwardly linear alignment by the ergonomic hand grips 116.

The hand tool for mechanical electrical connectors 102 is able to be manufactured in various sizes for various applications in addition to various mechanical electrical connectors 148. It may be further noted that the hand tool for mechanical electrical connectors 102 may be manufactured using a composite material.

Referring now to a preferred embodiment the hook nose pliers system 100 comprises: a set of pliers having a linier crab claw configuration 101, at its distal end that includes a front section 106, an upper work member 108, a lower work member 110, an axle 112, a pair of elongated handles 114, a pair of ergonomic hand grips 116, a pivot point 118, a mid section 120, a rear section 122, an upper work member 124, a lower work member 126, an upper leveraging arm 132, a lower leveraging arm 130, an upper handle section 132, a lower handle section 134, an upper ergonomic hand grip 136, a lower ergonomic hand grip 138, and at least one releasably engagable leaf spring 139.

The set of pliers are configured with a front section 106, to extend forward from the pivot point 118, and the pivot point 118, is rotatable on the axle 112. The work members include a linear crab claw configuration 101, and the linear crab claw configuration 101, is defined by a linear arcuate, convexly curved contour 142. The axle 112 is positioned at the mid section 120, and the mid section 120, extends rearwardly to provide a pliers-configuration.

The pliers-configuration includes an upper work member 108, in working linear alignment to a lower work member 110, wherein the upper work member 108, is in linear alignment to the lower work member 110, and pivotably and intersectionally formed around the axle 112, forming a pivot point 118. The upper work member 108, further extends rearwardly of the pivot point 118, creating a lower leveraging arm 130, and the lower working member extends rearwardly of the pivot point 118 creating a upper leveraging arm 128, and the lower leveraging arm 130 and upper leverage arm 128, include an upper handle section 129, and a lower handle section 131, respectively, extending rearwardly therefrom. The upper handle section 129, and lower handle section 131, may include an ergonomic hand grip 116, and the ergonomic hand grip 116 configuration may further include at least one releasably engagable leaf spring frictionally held in a forward extending linier alignment 139. In this way the present invention provides an efficient tool for use with the fasteners described and other such applications.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

1. A hook nose pliers system comprising:
a set of pliers having a linear crab claw configuration at its distal end;
a front section;
an upper work member;
a lower work member;
an axle;
a pair of elongated handles; and
a pair of ergonomic grips;
wherein said set of pliers is configured with said front section to extend forward from a pivot point,
wherein said pivot point is rotatable on said axle,
wherein said upper work members and said lower work member include said linear crab claw configuration, and
wherein said linear crab claw configuration comprises a linear arcuate, convexly curved contour configured to disengage a retaining lock of mechanical electrical connectors.

2. (canceled)

3. The hook nose pliers system of claim 2, wherein the, hand tool for mechanical electrical connectors is made of high strength alloy.

4. The hook nose pliers system of claim 3, wherein the, front section is triangular in shape having a small point and expanding in width rearwardly.

5. The hook nose pliers system of claim 4, wherein, at least, a portion of said front section has said crab claw configuration.

6. The hook nose pliers system of claim 5, wherein the, front section is integral to a mid section that provides a journal for receiving said axle.

7. The hook nose pliers system of claim 6, wherein the front section is defined by a pair of said upper work member and said lower work members in functional combination.

8. The hook nose pliers system of claim 7, wherein the pair of said upper work member and said lower work members are connected with and extending from ends of said mid section.

9. The hook nose pliers system of claim 8, wherein the mid section further includes a pair of leveraging arms extending rearwardly.

10. The hook nose pliers system of claim 8, wherein the pair of said upper work member and said lower work members pivot around said axle.

11. The hook nose pliers system of claim 10, wherein at least, a portion of said leveraging arms has said arcuate, convexly curved contour including a pair of ergonomic hand grips having a hollow body.

12. The hook nose pliers system of claim 11, wherein the ergonomic hand grips each having said hollow body are configured to fit tightly about an outer surface of said leveraging arms.

13. The hook nose pliers system of claim 12, wherein the ergonomic hand grips are made of electrical insulating material.

14. The hook nose pliers system of claim 13, wherein the at least one releasably engagable leaf spring is frictionally held in a forwardly linear alignment by said ergonomic hand grips.

15. The hook nose pliers system of claim 1, wherein the hand tool for mechanical electrical connectors is able to be manufactured in various sizes for various applications to said mechanical electrical connectors.

16. The hook nose pliers system of claim 15, wherein the hand tool for mechanical electrical connectors is manufactured using a composite material.

17. A hook nose pliers system, the hook nose pliers system comprising:
a set of pliers having a linear crab claw configuration at its distal end;
a front section;
an upper work member;
a lower work member;
an axle;
a pair of elongated handles;
a pair of ergonomic grips;
a pivot point,
a mid section,
a rear section,
a upper work member,
a lower work member,
an upper leveraging arm,
a lower leveraging arm,
an upper handle section,
a lower handle section,
an upper ergonomic hand grip,
a lower ergonomic hand grip, and
at least one releasably engagable leaf spring,
wherein said set of pliers is configured with said front section to extend forward from said pivot point,
wherein said pivot point is rotatable on said axle,
wherein said work members include said linear crab claw configuration,
wherein said linear crab claw configuration comprises a linear arcuate, convexly curved contour,
wherein said axle is positioned at said mid section,
wherein said mid section extends rearwardly to provide a pliers-configuration,
wherein said pliers-configuration includes said upper work member in working linear alignment to said lower work member,
wherein said upper work member is in linear alignment to said lower work member and are pivotably and intersectionally formed around said axle forming said pivot point,
wherein said upper work member extends rearwardly of said pivot point to creating the lower leveraging arm, and said lower working member extends rearwardly of said pivot point creating the upper leveraging arm,
wherein said lower leveraging arm and upper leverage arm further include an upper handle section and a lower handle section, respectively, extending rearwardly therefrom,
wherein said upper handle section and lower handle section have an ergonomic hand grip configuration, and
wherein said ergonomic hand grip configuration further includes said at least one releasably engagable leaf spring having a forward extending linear alignment.

18. The hook nose pliers system of claim 17, further comprising a set of instructions; and
wherein the hook nose pliers system is arranged as a kit to be sold with a plurality of fasteners.
